(19) United States
(12) Patent Application Publication
(10) Pub. No.: US 2011/0122352 A1
(43) Pub. Date: May 26, 2011

(54) LIQUID CRYSTAL DISPLAY

(75) Inventors: Seung-Gyu TAE, Yongin-city (KR); Chung Yi, Yongin-city (KR)

(73) Assignee: Samsung Mobile Display Co., Ltd., Yongin-city (KR)

(21) Appl. No.: 12/816,947

(22) Filed: Jun. 16, 2010

(30) Foreign Application Priority Data
Nov. 23, 2009 (KR) 10-2009-0113588

(51) Int. Cl. G02F 1/1333

(52) U.S. Cl. 349/138

(57) ABSTRACT

A liquid crystal display is disclosed. In one embodiment, the display includes i) a first substrate, ii) a first insulating layer comprising a light shielding layer, formed on the first substrate, wherein the light shielding layer comprises a metal, iii) a second insulating layer formed on the first insulating layer, iv) an electrode pattern formed on the second insulating layer, and v) a light sensing device, comprising a semiconductor layer, wherein the light sensing device is formed on the first insulating layer.

### CROSS-REFERENCE TO RELATED APPLICATIONS

This application claims priority to and the benefit of Korean Patent Application No. 10-2009-0113588, filed on Nov. 23, 2009, in the Korean Intellectual Property Office, the entire content of which is incorporated herein by reference.

### BACKGROUND

1. Field

The field relates to a liquid crystal display, and more specifically, to a liquid crystal display that controls brightness (luminance) of backlight according to intensity (illumination) of external light.

2. Description of the Related Technology

Liquid crystal displays with electro-optical characteristics of liquid crystal may be classified into those using a passive matrix scheme and those using an active matrix scheme. The active matrix scheme includes a thin film transistor, has excellent resolution and moving picture implementation capability, and has been more widely used than the passive matrix scheme.

A liquid crystal display using a thin film transistor (TFT-LCD) includes a display panel where a liquid crystal is injected between two substrates, a backlight that is disposed at a rear surface of the display panel ,used as a light source, and a driver to drive the display panel. Light supplied from the backlight is incident onto the display panel, is modulated by the light crystal oriented according to the signal supplied from the driver, and is emitted to the outside, thereby displaying characters or images.

### SUMMARY OF CERTAIN INVENTIVE ASPECTS

One aspect is a liquid crystal display. The display includes a first substrate and a first insulating layer including a light shielding layer, formed on the first substrate, where the light shielding layer includes a metal. The display also includes a second insulating layer formed on the first insulating layer, an electrode pattern formed on the second insulating layer, and a light sensing device, including a semiconductor layer, where the light sensing device is formed on the first insulating layer.

Another aspect is a liquid crystal display including a first substrate and a first insulating layer including a light shielding layer, formed on the first substrate. The display also includes a second insulating layer formed on the first insulating layer, an electrode pattern formed on the second insulating layer, and a light sensing device, including a semiconductor layer, where the light sensing device is formed on the first insulating layer. The display also includes a gate line and a data line disposed on the first insulating layer, a thin film transistor connected at the intersection of the gate line and the data line, and a pixel electrode connected to the thin film transistor.

Another aspect is a liquid crystal display including a first substrate and a first insulating layer including a light shielding layer, formed on the first substrate. The display also includes a light sensing device, including a semiconductor layer, where the light sensing device is capacitively coupled to the light shielding layer, and current conducting parameters of the light sensing device are at least partly determined by a voltage of the light shielding layer.

### BRIEF DESCRIPTION OF THE DRAWINGS

FIG. 1 is a schematic perspective view of a liquid crystal display according to an embodiment;

FIG. 2 is a cross-sectional view of a liquid crystal display according to an embodiment;

FIG. 3 is a circuit diagram illustrating the operation of the liquid crystal display according to an embodiment;

FIG. 4 is a plan view of a light sensing device and a capacitor;

FIG. 5A is an equivalent circuit diagram of a light sensing device of a liquid crystal device of the related art;

FIG. 5B is a graph showing output current characteristics of the light sensing device of FIG. 5A;

FIG. 6A is an equivalent circuit diagram of a light sensing of a liquid crystal device according to tan embodiment; and

FIG. 6B is a graph showing output current characteristics of the light sensing device of FIG. 6A.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various ways, without departing from the spirit or scope of the present invention.

Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals generally refer to like elements throughout the specification.

Liquid crystal display devices using a backlight may have high power consumption, thereby increasing the requirements for the capacity and size of the battery of portable electronic devices.

Power consumption requirements may be reduced by controlling the brightness (luminance) of the backlight according to the intensity (illumination) of the external light.

Korean Patent Publication No. 10-2008-0106637 (Dec. 12, 2008) discloses a liquid crystal display where a sensor unit is formed at a peripheral region and the supply of light of the backlight is controlled according to the intensity of the external light sensed by the sensor.

However, since the sensor unit, which generates light current according to the incident amount of the external light, is formed of a doped polysilicon layer, the liquid crystal display has problems in that the efficiency of sensing the external light is degraded or a malfunction occurs.

Korean Patent Publication No. 10-2008-0035360 discloses a liquid crystal display that prevents the malfunction of a light sensing device by shielding light supplied from the backlight by a light shielding pattern.

However, in the liquid crystal display the light shielding pattern is independently formed and electrically floated, which serves as a factor of providing a bias to a semiconductor layer (silicon layer) that configures the light sensing device. Therefore, when a bias is supplied to the semiconductor layer that maintains a depletion state, the output current of the light sensing device is changed such that a malfunction may occur.

FIG. 1 is a schematic perspective view of a liquid crystal display according to an embodiment, wherein a display panel 100, which displays images, is described.

The display panel 100 includes two substrates 110 and 210 facing each other and a liquid crystal layer 300 interposed between the two substrates 110 and 210. Light supplied from a backlight (not shown) is incident onto the liquid crystal layer 300 and is modulated by a liquid crystal oriented by voltage applied to a pixel electrode 128 and a common electrode 230 and then emitted to the outside through a substrate 210, thereby displaying characters or images.

A plurality of gate lines 130 and a plurality of data lines 140, which are arranged in a matrix form, are formed on the substrate 110. Pixel regions P are defined by the plurality of gate lines 130 and the plurality of data lines 140. Where the gate line 130 and the data line 140 intersect with each other on the substrate 110, a thin film transistor, T, a pixel electrode 128 connected to the thin film transistor, T, and a capacitor (not shown) are formed. The thin film transistor, T, controls signals supplied to each pixel, and the capacitor maintains the signals. A light sensing device (not shown), which senses the intensity of the external light, is also formed on the substrate 110.

A color filter 220 and a common electrode 230 are formed on the substrate 210. Polarizers 150 and 240 are respectively formed on the rear surface of the substrates 110 and 210, and the backlight (not shown), to be used as a light source, is disposed on the lower part of the polarizer 150.

In addition, a driver (LCD drive IC) (not shown), which drives the pixels, is mounted on the display panel 100. The driver converts an electrical signal supplied from the outside into a scan signal, supplied to gate line 130, and a data signal supplied to data line 140.

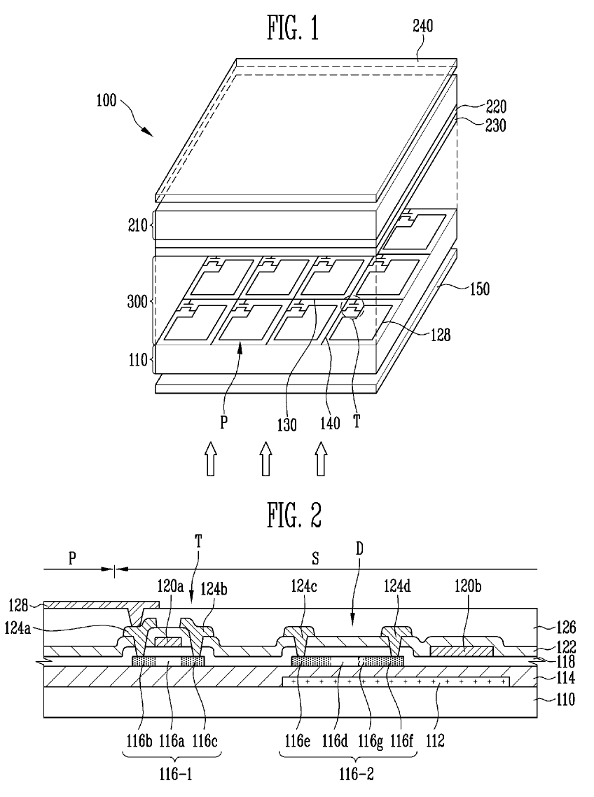

FIG. 2 is a cross-sectional view of a liquid crystal display according to an embodiment, wherein the pixel region, P, and the device forming region, S, are schematically shown.

The substrate 110 includes the pixel region P and the device forming region S. The thin film transistor T, the capacitor (not shown), and the light sensing device (D) are formed on the substrate 110 of the device forming region S.

A light shielding layer 112 is formed on the substrate 110 of the lower part of the light sensing device D and a first insulating layer 114 is formed on the substrate 110 including the light shielding layer 112. The light shielding layer 112 shields light supplied to the light sensing device D through the substrate 110 from the backlight and therefore, is made of a metal so as not to transmit light.

The thin film transistor T and the light sensing device D are formed on the first insulating layer 114.

The thin film transistor T includes a semiconductor layer 116-1 that is formed on the first insulating layer 114. The semiconductor layer includes a channel region 116a, a source region 116b, and a drain region 116c. A second insulating layer 118 is formed on the semiconductor layer 116-1. A gate electrode 120a that is formed on the second insulating layer 118 in the channel region 116a A third insulating layer 122 is formed on the second insulating layer 118 including the gate electrode 120a. The third insulating layer 122 is formed with a contact hole to expose the source region 116b and the drain region 116c of the semiconductor layer 116-1. A source electrode 124a and a drain electrode 124b are respectively connected to the source region 116b and the drain region 116c of the semiconductor layer 116-1 through the contact hole. The semiconductor layer 116-1 may be made of amorphous silicon or polysilicon.

The light sensing device D is formed of the semiconductor layer 116-2 and is comprises a PN or a PIN junction structure. For example, a PIN junction structure may include: a P+ type high concentration impurity region 116e, an N+ type high concentration impurity region 116f spaced away from the P+ type high concentration impurity region, an intrinsic semiconductor region 116d is disposed between the P+ type high concentration impurity region 116e and the N+ type high concentration impurity region 116f, and an N− type low concentration impurity region 116g adjacent to the N+ type impurity region 116f The P+ type impurity region 116e and the N+ type impurity region 116f may be connected to electrodes 124c and 124d through the contact holes formed in the second and third insulating layers 118 and 122. The semiconductor layer 116-2 may be made of amorphous silicon or polysilicon.

The light sensing device D converts an optical signal into an electric signal. The light sensing device functions in a reverse bias state. A negative voltage is applied to the P+ type impurity region 116e when light is incident into the N+ type impurity region 116f When a ground voltage or a positive voltage is applied, electrons and holes move along a depletion region formed in the intrinsic semiconductor region 116d. Current is output in proportion to the intensity of light. The brightness (luminance) of the backlight is controlled according to the current output from the light sensing device, D, thereby making it possible to reduce the power consumption.

In addition, the electrode pattern 120b is formed to overlap the light shielding layer 112. A capacitance is formed by the stacked structure of the light shielding layer 112, the first insulating layer 114, the second insulating layer 118, and the electrode pattern 120b. The electrode pattern 120b may be made with the same material as the gate electrode 120a.

A planarization layer 126 is formed on the substrate 110. The planarization layer includes the device forming region, S, which includes the thin film transistor, T, and the light sensing device, D, the pixel region, P, and a via hole which is formed in the planarization layer 126 to expose the source electrode 124a or the drain electrode 124b. The pixel electrode 128 is formed on the planarization layer 126 including the pixel region P so that it is connected to the source electrode 124a or the drain electrode 124b through the via hole.

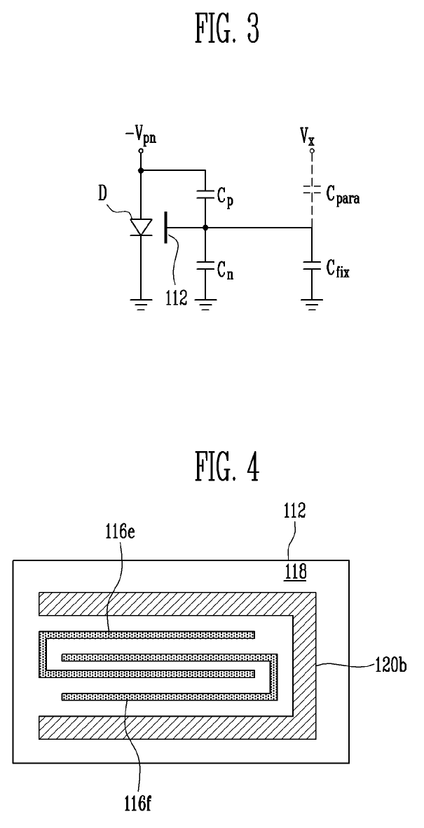

FIG. 3 is an equivalent circuit diagram illustrating the operation of the light sensing device D and the capacitor formed of the light shielding layer 112, the first insulating layer 114, the second insulating layer 118, and the electrode pattern 120b.

An operating voltage −Vpn and a ground voltage are applied to the P+ type impurity region 116e and the N+ type impurity region 116f of the light sensing device D, respectively, and the ground voltage is, for example, applied to the electrode pattern 120b. The drawing shows Cp, representing the capacitance between the light shielding layer 112 and the P+ type impurity region 116e, Cn, representing the capacitance between the light shielding layer 112 and the N+ type impurity region 116f, and Cpara, representing the capacitance between the electrode pattern 120b having an operating voltage Vx and the light shielding layer 112. In addition, Cfix represents the capacitance according to the stacking structure of the light shielding layer 112, the insulating layers 114 and 118, and the electrode pattern 120b.

A voltage Vshield (not shown), which can be applied to the light shielding layer 112, may be represented by the following Equation 1.

Vshield=Cpara/(Cfix+Cpara)·Vx Equation 1

When the capacitance Cfix is larger than the capacitance Cpara, the influence of the bias applied to the light shielding layer 112 on the operation of the light sensing device D can be minimized by the capacitance Cpara. In other words, a relatively small capacitance Cpara may be disregarded. The potential between the light shielding layer 112 and ground is stably and uniformly maintained by the capacitance Cfix, thereby making it possible to make the output current characteristics of the light sensing device D uniform.

In order to maximize capacitance in the limited area, it is preferable that the electrode pattern 120b be formed to at least partly surround the light sensing device D as shown in FIG. 4. Further, the thickness of the first insulating layer 114 and the second insulating layer 118, which form the dielectric of the capacitor Cfix, can be minimized. Alternatively, only one of the first insulating layer 114 or the second insulating layer 118 can be selectively used.

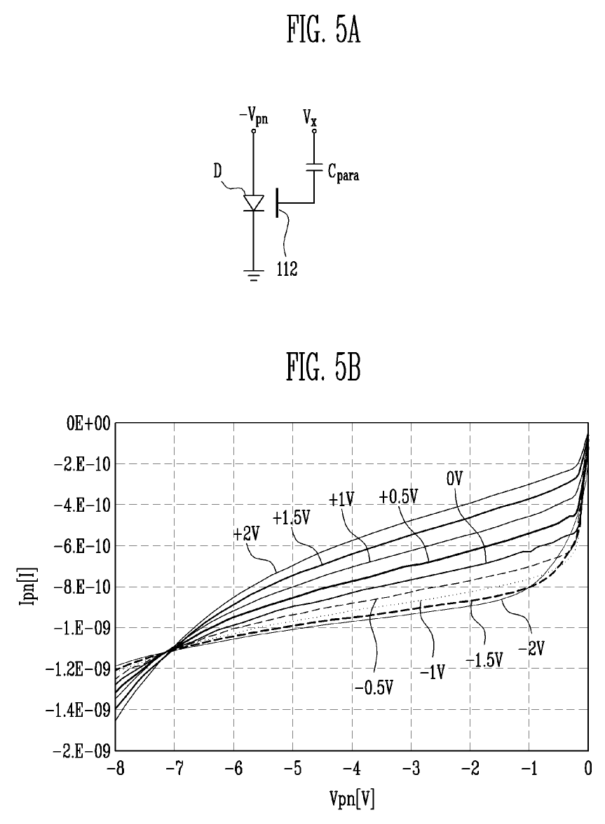

FIG. 5A is an equivalent circuit diagram illustrating an operating voltage of −Vpn of 0 to −8V being applied to the P+ type impurity region 116e and the N+ type impurity region 116f, and a bias of a predetermined voltage (Vx=+2V˜−2V) being applied to the light shielding layer 112 by the capacitance Cpara. As shown in FIG. 5B, the current characteristics of the light sensing device D are changed according to the bias applied to the light shielding layer 112. The change in the current characteristics demonstrates that the output current (Ipn) characteristics of the light sensing device D vary according to the intensity (illumination) of the external light.

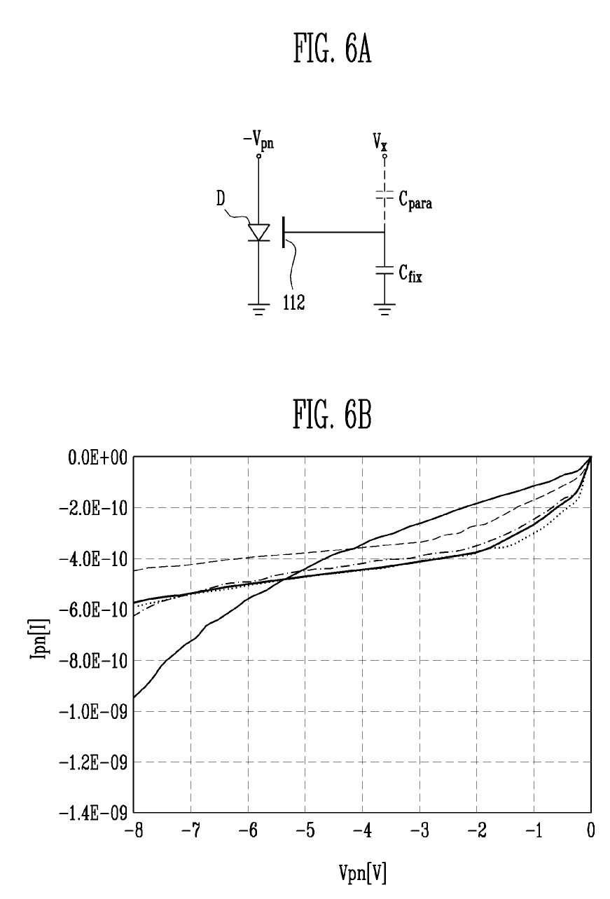

FIG. 6A is an equivalent circuit diagram illustrating an operating voltage of −Vpn of 0 to −8V being applied to the P+ type impurity region 116e and the N+ type impurity region 116f, and the potential of the light shielding layer 112 being uniformly maintained by the capacitance Cfix. When the bias of the predetermined voltage is applied to the light shielding layer 112 by the capacitance Cpara, the output current characteristics of the light sensing device D are as shown in FIG. 6B. The stable current characteristic demonstrate that the output current Ipn of the light sensing device D varies substantially linearly and uniformly according to the intensity of the external light.

The output current characteristics of the light sensing device D change according to the intensity of the external light, based on processing parameters and/or the environment. However, when the voltage applied to the electrode pattern 120b is controlled, the potential of the light shielding layer 112 can be controlled for each display panel, thereby making the output current characteristics of the light sensing device D uniform, regardless of the intensity of the external light.

Furthermore, in order to uniformly maintain the potential of the light shielding layer 112, the predetermined voltage may be directly applied to the light shielding layer 112. To apply the voltage, a contact hole that connects the wiring to the light shielding layer 112 is formed. A capacitor Cfix which is formed of the light shielding layer 112, the insulating layers 114 and 118, and the conductive pattern 120b, can be used by using the same process as the one for manufacturing the thin film transistor T.

Although this embodiment describes a case where the light sensing device is a diode, the light sensing device can be a photo transistor made using the process for manufacturing the thin film transistor T.

While the present invention has been described in connection with certain exemplary embodiments, it is to be understood that the invention is not limited to the disclosed embodiments, but, on the contrary, is intended to cover various modifications and equivalent arrangements.

What is claimed is:

1. A liquid crystal display, comprising:
a first substrate;
a first insulating layer comprising a light shielding layer, formed on the first substrate, wherein the light shielding layer comprises a metal;
a second insulating layer formed on the first insulating layer;
an electrode pattern formed on the second insulating layer; and
a light sensing device, comprising a semiconductor layer, wherein the light sensing device is formed on the first insulating layer.

2. The liquid crystal display of claim 1, wherein the semiconductor layer of the light sensing device comprises a first impurity region and a second impurity region, wherein the first and second impurity regions are spaced apart from each other.

3. The liquid crystal display of claim 2, wherein the semiconductor layer of the light sensing device further comprises a third impurity region adjacent to the second impurity region.

4. The liquid crystal display of claim 1, wherein the electrode pattern at least partly surrounds the light sensing device.

5. The liquid crystal display of claim 1, further comprising:
a gate line and a data line disposed on the first insulating layer, wherein the gate line and the data line intersect one another;
a thin film transistor connected between the gate line and the data line; and
a pixel electrode connected to the thin film transistor.

6. The liquid crystal display of claim 5, wherein the thin film transistor comprises:
a semiconductor layer formed on the first insulating layer, wherein the semiconductor layer comprises a source region, a drain region, and a channel region;
a second insulating layer formed on the semiconductor layer;
a gate electrode in the channel region of the semiconductor layer, formed on the second insulating layer;
a third insulating layer formed on the second insulating layer, wherein the third insulating layer comprises the gate electrode and a contact hole to expose the source region and the drain region of the semiconductor layer; and
a source electrode and a drain electrode respectively connected to the source region and the drain region of the semiconductor layer through the contact hole.

7. The liquid crystal display of claim 6, wherein the semiconductor layer is made of amorphous silicon or polysilicon.

8. The liquid crystal display of claim 6, wherein the electrode pattern and the gate electrode are made with the same material.

9. The liquid crystal display of claim 1, further comprising:
a second substrate facing the first substrate:
a common electrode formed on the second substrate; and
a liquid crystal layer positioned between the first substrate and the second substrate.

10. The liquid crystal display of claim 1, wherein a ground voltage is applied to the electrode pattern.

11. The liquid crystal display of claim 1, wherein the semiconductor layer is made of amorphous silicon or polysilicon.

12. The liquid crystal display of claim 1, further comprising a backlight, wherein the luminance of the backlight is based at least in part on an output from the light sensing device.

13. A liquid crystal display comprising:
a first substrate;
a first insulating layer comprising a light shielding layer, formed on the first substrate;
a second insulating layer formed on the first insulating layer;
an electrode pattern formed on the second insulating layer;
a light sensing device, comprising a semiconductor layer, wherein the light sensing device is formed on the first insulating layer;
a gate line and a data line disposed on the first insulating layer;
a thin film transistor connected at the intersection of the gate line and the data line; and
a pixel electrode connected to the thin film transistor.

14. The liquid crystal display of claim 13, wherein the light shielding layer comprises a metal.

15. The liquid crystal display of claim 13, wherein the thin film transistor comprises:
a source region, a drain region, and a channel region;
a gate electrode near the channel region;
a contact hole to expose the source region and the drain region in the semiconductor layer; and
a source electrode and a drain electrode respectively connected to the source region and the drain region through the contact hole.

16. The liquid crystal display of claim 13, further comprising a backlight, wherein the luminance of the backlight is based at least in part on an output from the light sensing device.

17. A liquid crystal display comprising:
a first substrate;
a first insulating layer comprising a light shielding layer, formed on the first substrate;
a light sensing device, comprising a semiconductor layer, wherein the light sensing device is capacitively coupled to the light shielding layer, and current conducting parameters of the light sensing device are at least partly determined by a voltage of the light shielding layer.

18. The liquid crystal display of claim 17, further comprising an electrode capacitively coupled to the light shielding layer, wherein current conducting parameters of the light sensing device are at least partly determined by a voltage of the electrode.

19. The liquid crystal display of claim 18, wherein the electrode at least partly surrounds the light sensing device.

20. The liquid crystal display of claim 17, further comprising a backlight, wherein the luminance of the backlight is based at least in part on an output from the light sensing device.
